(19) United States
(12) Patent Application Publication
(10) Pub. No.: US 2006/0087845 A1
(43) Pub. Date: Apr. 27, 2006

(54) Knife structure

(76) Inventor: Ming-Hsiang Yeh, Taipei City (TW)

Correspondence Address: TROXELL LAW OFFICE PLLC;SUITE 1404, 5205 LEESBURG PIKE, FALLS CHURCH, VA, 22041, US

(21) Appl. No.: 10/968,937

(22) Filed: Oct. 21, 2004

(51) Int. Cl. F21V 33/00

(52) U.S. Cl. 362/253

(57) ABSTRACT

A knife structure is disclosed. The knife structure mainly comprises: a main body having at least a foldable tool on one side thereof and a media player mounted on the other side thereof, wherein the media player comprises a plurality of function keys, a microphone, a camera lens, a speaker, a storage device, and an output/input device. Therefore, the knife structure provides the knife tools and can be used as an entertaining object to listen to digital music, take photograph and film, or make audio recording.

### BACKGROUND OF THE INVENTION

The present invention relates to a knife structure, which is used to listen to music, take photograph and film, or make audio recording, and more particularly to a Swiss army knife, a foldable knife, or the like.

Knife is a kind of very convenient and practical device. The common knife is such as a pocketknife, an art knife, a penknife, etc. Because of diversity of function requirements, the pocketknife with a single blade is no longer a preferable choice. The pocketknife is gradually replaced by one of popular multi-function knifes such as Swiss army knife that assembles various tools, for example, a blade, a nail file, and a bottle opener.

Generally speaking, there are fewer chances to utilize the Swiss army knife indoors. The Swiss army knife is usually utilized outdoors. Since it is inconvenient at outside, user must prepare for every necessary tool by himself. However, in order to lessen baggage weight only the essential articles are carried with absence of other inessential articles. In this way, it is boring for user to stay outside in spite of less article weight and article types.

The present invention has been made in view of the above circumstances and provides a portable knife structure with usableness. The present inventor has been made diligent studies with a quiet mind to design and fabricate a knife structure that enables user to listen to music, take photograph and film, or make audio recording. This knife structure is provided for the consumer in accordance with motivations of the present invention.

### SUMMARY OF THE INVENTION

The primary purpose of the present invention is to provide a knife structure having a plurality of foldable tools so as to enable user to listen to digital music, take photograph and film, or make audio recording during using the knife structure.

According to the aforementioned purposes of the present invention, a knife structure is disclosed. The knife structure mainly comprises: a main body having at least a foldable tool on one side thereof and a media player mounted on the other side thereof, wherein the media player comprises a plurality of function keys, a microphone, a camera lens, a speaker, a storage device, and an output/input device. Therefore, the knife structure can be used to cut something and can be used as an entertaining object to listen to digital music, take photograph and film, or make audio recording.

The other features and preferred embodiments of the present invention will now be described with reference to the accompanying drawings.

### BRIEF DESCRIPTION OF THE DRAWINGS

FIG. 1 is a perspective view showing the outward appearance of a preferred embodiment of the present invention.

FIG. 2 is a schematic view showing unfolded tools of the preferred embodiment of the present invention.

FIG. 2A is diagram showing another illustration of the preferred embodiment of the present invention.

FIG. 3 is a schematic view showing the usage of the preferred embodiment of the present invention.

FIG. 4 is a schematic view showing another usage of the preferred embodiment of the present invention.

### DETAILED DESCRIPTION OF THE PREFERRED EMBODIMENT

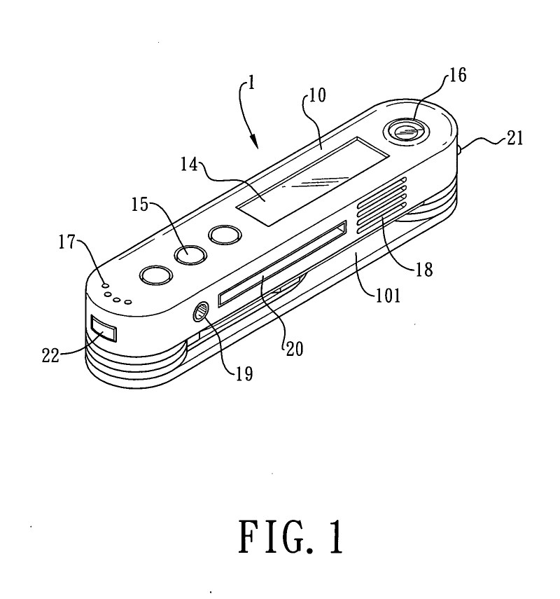

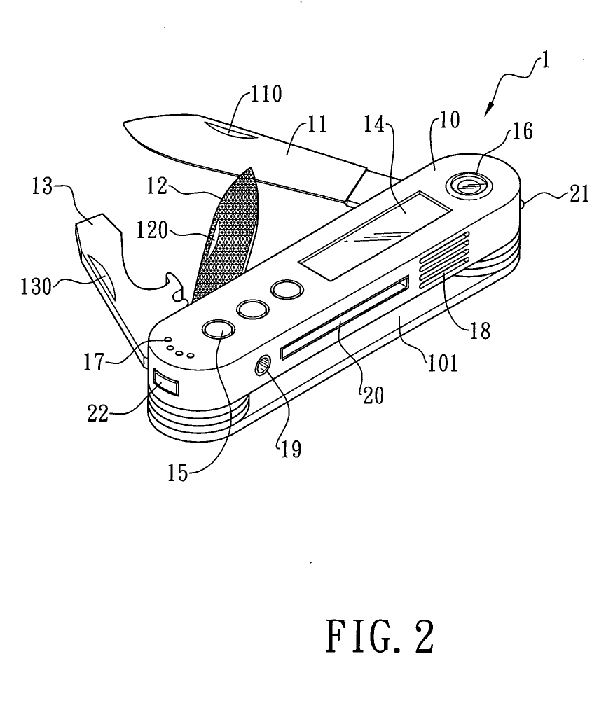

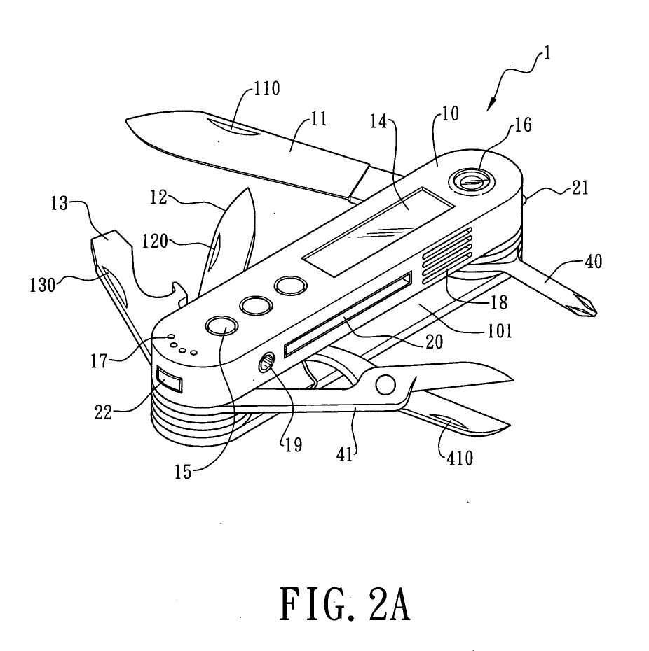

Referring to FIG. 1 and FIG. 2, the knife structure 1 of the present invention mainly comprises a handle body 10. A trench 101 is mounted in one side of the handle body 1. A shaft is respectively mounted on two ends of the trench 101 so as to pivotally connect to a blade 11, a nail file 12, and a bottle opener 13. In order to use the present invention, the user can uses his fingers to pull out the blade 11, the nail file 12, and the bottle opener 13 by using notches 110, 120, and 130 mounted respectively on the top of them. A monitor 14, a plurality of function keys 15, a camera lens 16, a microphone 17, a speaker 18, an earphone jack 19, a storage device slot 20, a LED light 21, and an identifier 22 are mounted on the other side and peripheral of the handle body 10. A central processing unit (CPU) is mounted on the inside of the handle body 10, wherein the CPU is further connected to an analog to digital converter, a digital to analog converter, an audio amplifier, a digital signal processor, a transmission interface so as to from a MP3 playing circuit, and the CPU is further connected to the camera lens 16 and a Bluetooth chip module. Moreover, the identifier 22, which is mounted on the handle body 10, is a RFID (Radio Frequency Identification) system.

Owing to tools attached to the knife structure 1 are full of variety and not limited to the blade 11, the nail file. 12, and the bottle opener 13, etc. A lot of tools, for example, a screwdriver 40, a clipper 41, as shown in FIG. 2A, can be mounted on the knife structure 1 to facilitate user to use the knife structure 1.

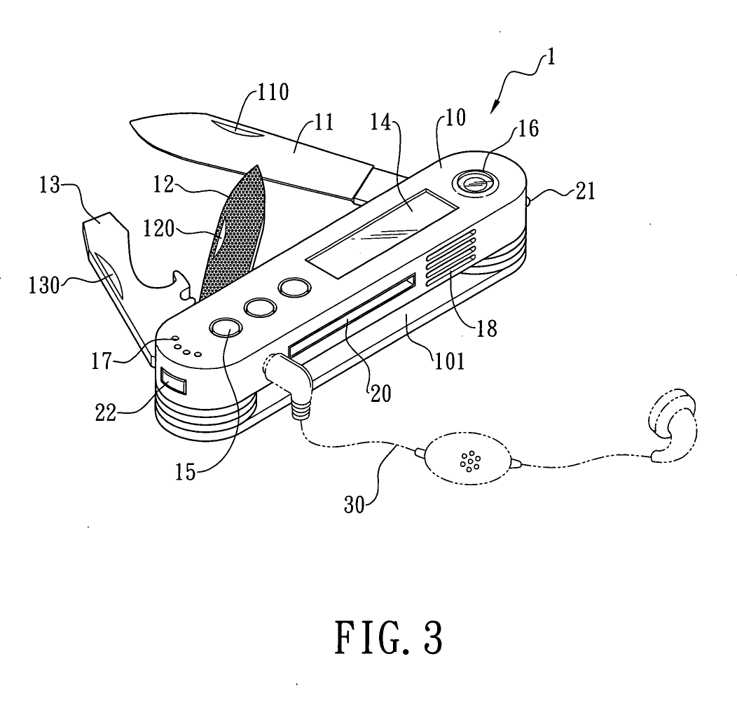

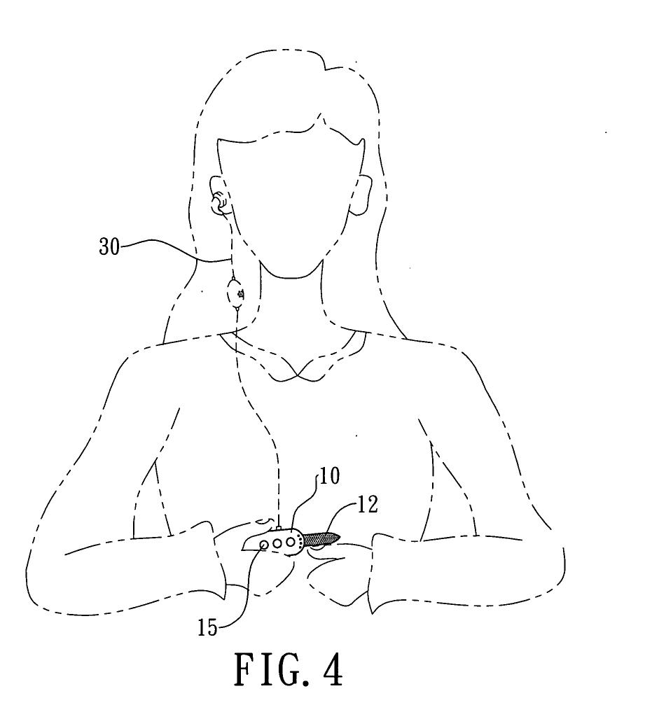

Referring to FIG. 3 and FIG. 4, user can put his fingers on the notches 110, 120, or 130, which are mounted on the top portion of the respective tool of the handle body 10, so as to pull the tool such as blade 11 away the trench 101 for using the blade 11. In addition, no matter when the knife structure 1 is in use or not, a hand-free mobile phone handset 30 can be plugged into the earphone jack 19 on the handle body 10. When the knife structure 1 is turned on, the handset 30 is used to show the digital music stored in the handle body 10 in normal situation. If there is an incoming call for the user who carries the mobile phone, the handle body 10 will automatically change the status of showing music to the status of answering call once the Bluetooth chip module receives a signal of the incoming call. Therefore, the user will not miss the timing to answer the call because it is not necessary for the user to look for the mobile phone. Meanwhile, a card reader can access RFID codes stored in the identifier 22 of the handle body 10 so as to open the door panel thereby achieving the purpose of entrance control.

Furthermore, the LED light 21 mounted on the handle body 10 is a laser pointer, which is applied to a meeting or a briefing. By means of pressing the function keys 15, recording of published content in the meeting or the briefing can be made. Besides, by means of the camera lens 10, the handle body 10 can be used to take photograph and film or used as a network camera such that the knife structure 1 is not an ordinary knife tool. The knife structure 1 can be easily applied to listen to music, answer call, take photograph and film, or make any audio or video recording when the knife structure is in use so as to relax user's mind thought music during work.

However, the above description merely illustrates the preferred embodiments of the present invention, and the applicable scope of the present invention is not limited hereto. Any obvious modification and revision made by a person skilled in the art are included within the spirit and scope of the present invention.

As described above, the present invention provides a knife structure that enables user to not only use the tools mounted in the handle body but also listen to digital music, take photograph and film, make audio recording, etc. Besides, the knife structure can be used as an entrance card and a laser pointer. The application that complies with utility is therefore submitted for a patent.

What the invention claimed is:

1. A knife structure comprising:
a handle body having a trench mounted on one side thereof for receiving at least a foldable tool and a media player mounted on the other side thereof, wherein the media player comprises a plurality of function keys, a monitor, a LED light, an identifier, a microphone, a camera lens, a speaker, a storage device, and an output/input device, and
thereby the knife structure provides a knife tool and can be used as an entertaining object to listen to digital music, take photograph and film, or make audio recording.

2. The knife structure of claim 1, wherein the handle body is a Swiss army knife or a foldable knife.

3. The knife structure of claim 1, wherein the identifier on the handle body is a radio frequency identification system.

4. The knife structure of claim 1, wherein a Bluetooth chip module is mounted inside the handle body.
